(19) United States
(12) Patent Application Publication
(10) Pub. No.: US 2010/0073546 A1
(43) Pub. Date: Mar. 25, 2010

(54) Image Processing Device And Electric Apparatus

(75) Inventor: Yukio MORI, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Osaka (JP)

(21) Appl. No.: 12/566,805

(22) Filed: Sep. 25, 2009

(30) Foreign Application Priority Data
Sep. 25, 2008 (JP) 2008245665

(51) Int. Cl. H04N 5/225

(52) U.S. Cl. 348/333.12; 348/E05.024

(57) ABSTRACT

A combination processing portion is provided with: an enlargement portion that enlarges a reduced image obtained by reducing an input image to output an enlarged image; a combination portion that combines together a clipped image generated by clipping a portion of the input image and the enlarged image to generate a combined image; an angle-of-view setting portion that sets a playback angle-of-view region; an on-playback clipping portion that clips the playback angle-of-view region from the combined image to generate an angle-of-view resetting image; and an image size adjustment portion that adjusts the size of the angle-of-view resetting image output from the on-playback clipping portion.

This nonprovisional application claims priority under 35 U.S.C. §119(a) on Patent Application No. 2008-245665 filed in Japan on Sep. 25, 2008, the entire contents of which are hereby incorporated by reference.

### BACKGROUND OF THE INVENTION

1. Field of the Invention

The present invention relates to an image processing device that clips a portion of an input image to obtain a desired clipped image and an electronic apparatus incorporating such an image processing device.

2. Description of the Related Art

In recent years, image sensing devices, such as a digital still camera and a digital video camera, that sense an image with an image sensor such as a CCD (charge coupled device) or a CMOS (complimentary metal oxide semiconductor) sensor and display devices, such as a liquid crystal display, that display an image have been widely used. As these sensing devices and display devices, there are provided devices that clip a predetermined region from an image to be processed (hereinafter referred to as an input image) and that record and display the image of the clipped region (hereinafter, a clipped image).

Such clipping processing allows the shooting of an image to be simplified. Specifically, for example, an input image of a wide angle of view is shot by a user, the clipping processing is performed on the input image obtained and clipping processing is performed on a region including the image of a subject (hereinafter, a main subject) that the user especially wishes to shoot. This clipping processing eliminates the need for the user to concentrate on following the main subject in order to obtain an image including the image of the main subject. In particular, simply facing the image sensing device toward the main subject is all that is required.

Disadvantageously, however, when the clipped image is only recorded, it is impossible to obtain a desired image if the clipping processing is improperly performed. In particular, even if the user wishes to check the image of regions other than the clipped region, since the image of the regions other than the clipped region is not recorded, the image of the regions cannot be checked on playback, with the result that this becomes a problem.

To overcome this problem, there is proposed an image sensing device that records both an input image and a clipped image and that arranges and displays them side by side on playback. Recording the images with this image sensing device makes it possible for the user to check the image of the regions other than the clipped region on playback.

Disadvantageously, however, when a plurality of images are recorded simultaneously, the amount of data recorded is increased, with the result that it is time-consuming to perform different types of processing. When a plurality of images are arranged and displayed side by side, it is necessary for the user to compare the images to check the desired region. Thus, it is troublesome to check the images.

### SUMMARY OF THE INVENTION

According to one aspect of the present invention, there is provided an image processing device including: an enlargement processing portion enlarging a reduced image obtained by reducing an input image to generate an enlarged image; a combination portion combining a clipped image that is an image clipped from a clip region that is a partial region of the input image with an image of a region of the enlarged image corresponding to the clip region to generate a combined image; and an on-playback clipping portion clipping a playback angle-of-view region that is a partial region of the combined image to generate an angle-of-view resetting image.

According to another aspect of the present invention, there is provided an electronic apparatus including the above-described image processing device, in which the electronic apparatus records or plays back an image output from the image processing device.

### BRIEF DESCRIPTION OF THE DRAWINGS

FIG. 1 is a block diagram showing the configuration of an image sensing device according to an embodiment of the present invention;

FIG. 2 is a block diagram showing the configuration of the primary portions of an image-sensing image processing portion of the embodiment of the invention;

FIG. 3 is a schematic diagram of an image showing an example of a face detection processing method;

FIG. 4A is a schematic diagram of an input image showing an example of a method of setting a clipped region;

FIG. 4B is a schematic diagram of the input image showing another example of the method of setting the clipped region;

FIG. 5A is a schematic diagram showing an example of a clipped image;

FIG. 5B is a schematic diagram showing an example of a reduced image;

FIG. 6 is a block diagram showing the configuration of the primary portions of a playback image processing portion of the embodiment of the invention;

FIG. 7 is a schematic diagram showing an example of an enlarged image;

FIG. 8 is a schematic diagram showing an example of a combined image;

FIG. 9 is a schematic diagram of the combined image showing an example of combination processing;

FIG. 10 is a schematic diagram of an enlarged image showing an example of a method of setting a playback angle-of-view region with an angle-of-view setting portion;

FIG. 11A is a schematic diagram showing an example of an angle-of-view resetting image;

FIG. 11B is a schematic diagram showing an example of an angle-of-view resetting image (after adjustment);

FIG. 12 is a flowchart showing an example of controlling a display image on the sensing of an image;

FIG. 13 is a schematic diagram showing an example of an output image;

FIG. 14 is a flowchart showing an example of controlling a display image on playback;

FIG. 15A is a graph showing the brightness distribution of a subject to be captured;

FIG. 15B is a reduced image when the subject shown in FIG. 15A is captured;

FIG. 15C is a reduced image when the subject shown in FIG. 15A is captured;

FIG. 15D is an image obtained by shifting the reduced image shown in FIG. 15C by a predetermined amount;

FIG. 16A is a diagram showing a method of estimating a high-resolution image from an actual low-resolution image;

FIG. 16B is a diagram showing a method of estimating an estimated low-resolution image from a high-resolution image;

FIG. 16C is a diagram showing a method of generating a difference image from the estimated low-resolution image and the actual low-resolution image;

FIG. 16D is a diagram showing a method of reconstructing the high-resolution image from the high-resolution image and the difference image;

FIG. 17 is a schematic diagram showing how an image is divided into regions in representative point matching;

FIG. 18A is a schematic diagram of a reference image showing the representative point matching;

FIG. 18B is a schematic diagram of a non-reference image showing the representative point matching;

FIG. 19A is a schematic diagram of the reference image showing single-pixel movement amount detection;

FIG. 19B is a schematic diagram of the non-reference image showing the single-pixel movement amount detection;

FIG. 20A is a graph showing a horizontal relationship between the pixels values of reference points and sampling points when the single-pixel movement amount detection is performed; and

FIG. 20B is a graph showing a vertical relationship between the pixels values of the reference points and the sampling points when the single-pixel movement amount detection is performed.

### DETAILED DESCRIPTION OF PREFERRED EMBODIMENTS

An embodiment of the present invention will be described below with reference to the accompanying drawings. An image sensing device that is an example of an electronic apparatus according to the invention will first be described. The image sensing device, which will be described below, is an image sensing device, such as a digital camera, that can record sound, a moving image and a still image.

<<Image Sensing Device>>

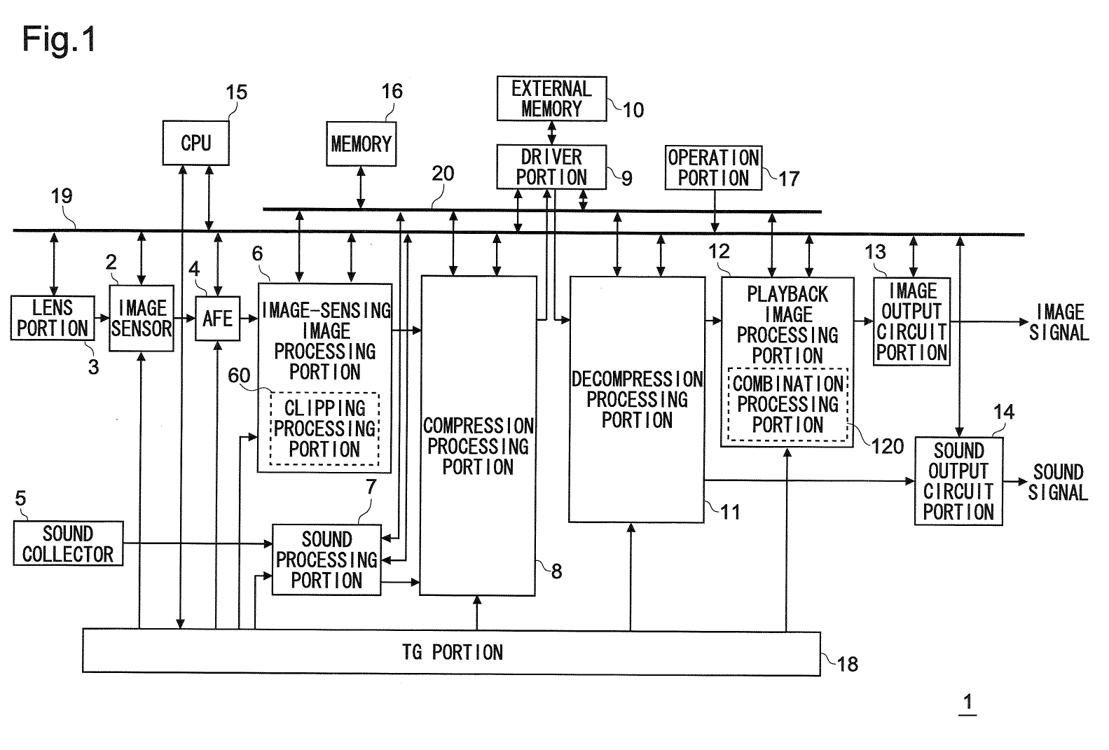

The configuration of the image sensing device will first be described with reference to FIG. 1. FIG. 1 is a block diagram showing the configuration of the image sensing device according to the embodiment of the invention.

As shown in FIG. 1, the image sensing device 1 is provided with: an image sensor 2 that is formed with a solid-state image sensing element such as a CCD or a CMOS sensor that converts an incoming optical image into an electrical signal; and a lens portion 3 that forms the optical image of a subject on the image sensor 2 and that adjusts the amount of light or the like. The lens portion 3 and the image sensor 2 constitute an image sensing portion, and this image sensing portion generates an image signal. The lens portion 3 includes various lenses (not shown) such as a zoom lens and a focus lens and an aperture (not shown) for adjusting the amount of light input to the image sensor 2.

The image sensing device 1 is also provided with: an AFE (analog front end) 4 that converts the analog image signal output from the image sensor 2 into a digital signal and that adjusts a gain; a sound collector 5 that converts input sound into an electrical signal; an image-sensing image processing portion 6 that performs various types of image processing on the image signal; a sound processing portion 7 that converts an analog sound signal output from the sound collector 5 into a digital signal; a compression processing portion 8 that performs, on the image signal output from the image-sensing image processing portion 6, compression-coding processing for still images such as a JPEG (joint photographic experts groups) compression method and that performs, on the image signal output from the image-sensing image processing portion 6 and the sound signal from the sound processing portion 7, compression-coding processing for a moving image such as a MPEG (moving picture experts group) compression method; an external memory 10 that records a compression-coded signal resulting from the compression-coding by the compression processing portion 8; a driver portion 9 that records and reads the image signal in and from the external memory 10; and a decompression processing portion 11 that decompresses and decodes the compression-coded signal read from the external memory 10 by the driver portion 9. The image-sensing image processing portion 6 is provided with a clipping processing portion 60 that clips a portion of the input image signal to obtain a new image signal.

Moreover, the image sensing device 1 is provided with: a playback image processing portion 12 that generates, based on an image signal resulting from the decoding by the decompression processing portion 11 and the image signal output from the image-sensing image processing portion 6, an image signal for playback; an image output circuit portion 13 that converts the image signal output from the playback image processing portion 12 into a signal in a form that can be displayed on a display device (not shown) such as a display; and a sound output circuit portion 14 that converts the sound signal resulting from the decoding by the decompression processing portion 11 into a signal in a form that can be played back by a playback device (not shown) such as a speaker. The playback image processing portion 12 is provided with a combination processing portion 120 that combines input image signals together to obtain a new image signal.

The image sensing device 1 is also provided with: a CPU (central processing unit) 15 that controls the overall operation within the image sensing device 1; a memory 16 that stores programs for performing different types of processing and that temporarily stores a signal when a program is executed; an operation portion 17 that has buttons such as for starting the sensing of an image and for determining various settings and that receives instructions from a user; a timing generator (TG) portion 18 that outputs a timing control signal for synchronizing the operation timings of individual portions; a bus 19 through which signals are exchanged between the CPU 15 and the individual portions; and a bus 20 through which signals are exchanged between the memory 16 and the individual portions.

There are no restrictions on the external memory 10 as long as it can record image signals and sound signals. For example, a semiconductor memory such as a SD (secure digital) card, an optical disc such as a DVD, a magnetic disk such as a hard disk or the like can be used as this external memory 10. The external memory 10 may be formed to be removable from the image sensing device 1.

The basic operation of the image sensing device 1 will now be described with reference to FIG. 1. First, in the image sensing device 1, light incident through the lens portion 3 is photoelectrically converted by the image sensor 2 and thus an image signal that is an electrical signal is acquired. Then, the image sensor 2 sequentially outputs image signals to the AFE 4 in synchronization with a timing control signal input from the TG portion 18 at a predetermined frame period (for example, 1/30 second). The image signal that is converted by the AFE 4 from an analog signal to a digital signal is then input to the image-sensing image processing portion 6.

In the image-sensing image processing portion 6, various types of image processing such as a gradation correction and an edge enhancement are performed. Image signals for a RAW image (an image whose pixels individually have a signal value for a single color) that are input to the image-sensing image processing portion 6 are subjected to simultaneous-coloring processing, and are thus converted into image signals for a simultaneous-colored image (an image whose pixels individually have signal values for a plurality of colors). The memory 16 operates as a frame memory, and temporarily stores the image signal when the image-sensing image processing portion 6 performs the processing. The simultaneous-colored image, for example, may have, in one pixel, a signal value for each of R (red), G (green) and B (blue) or may have a signal value for each of Y (brightness), U and V (color difference).

Here, in the lens portion 3, based on the image signal input to the image-sensing image processing portion 6, the positions of various lenses are adjusted and thus the focus is adjusted, and the degree of opening of the aperture is adjusted and thus the degree of exposure is adjusted. Moreover, based on the image signal that is input, the white balance is also adjusted. The adjustments of the focus, the exposure and the white balance are automatically performed based on a predetermined program such that their optimum states are achieved or they are manually performed based on instructions from the user.

The clipping processing portion 60 included in the image-sensing image processing portion 6 clips a portion of the input image signal to generate and output an image signal for the clipped image. The configuration and operation of the image-sensing image processing portion 6 including the clipping processing portion 60 will be described in detail later.

When a moving image is recorded, not only image signals but also sound signals are recorded. The electrical signal resulting from the conversion and output as the sound signal by the sound collector 5 is input to the sound processing portion 7, where the signal is digitalized and is subjected to processing such as noise elimination. Then, the image signal output from the image-sensing image processing portion 6 and the sound signal output from the sound processing portion 7 are input to the compression processing portion 8, where they are compressed by a predetermined compression method. Here, the image signal and the sound signal are processed such that they correspond in time to each other and that the image and sound are synchronized on playback. Then, the compressed image signal and sound signal are recorded in the external memory 10 through the driver portion 9.

On the other hand, when either a still image or sound is recorded, either an image signal or a sound signal is compressed by the compression processing portion 8 with a predetermined compression method and is recorded in the external memory 10. The processing performed by the image-sensing image processing portion 6 may be different depending on whether a moving image is recorded or a still image is recorded.

The compressed image signal and sound signal that are recorded in the external memory 10 are read by the decompression processing portion 11 based on instructions from the user. In the decompression processing portion 11, the compressed image signal and sound signal are decompressed. The decompressed image signal is input to the playback image processing portion 12, where an image signal for playback is generated. Here, as required, the combination processing portion 120 combines images together. The configuration and operation of the playback image processing portion 12 including the combination processing portion 120 will be described in detail later.

The image signal output from the playback image processing portion 12 is input to the image output circuit portion 13. The sound signal decompressed by the decompression processing portion 11 is input to the sound output circuit portion 14. Then, the image signal and the sound signal are converted by the image output circuit portion 13 and the sound output circuit portion 14 into signals in forms that can be displayed and played back by the display device and the speaker, and they are then output.

The display device and the speaker may be formed integrally with the image sensing device 1 or may be formed separately therefrom by being connected with terminals, cables or the like of the image sensing device 1.

When an image displayed on the display device or the like is checked by the user without the image signal being recorded or when a so-called preview is performed, the image signal output from the image-sensing image processing portion 6 may be output to the playback image processing portion 12 without being compressed. When the image signal for a moving image is recorded, the image signal is compressed by the compression processing portion 8 and is recorded in the external memory 10, and simultaneously the image signal may be output via the playback image processing portion 12 and the image output circuit portion 13 to the display device or the like.

The combination of the image-sensing image processing portion 6 and the playback image processing portion 12 can be understood as one image processing portion (one image processing device).

<Image-Sensing Image Processing Portion>

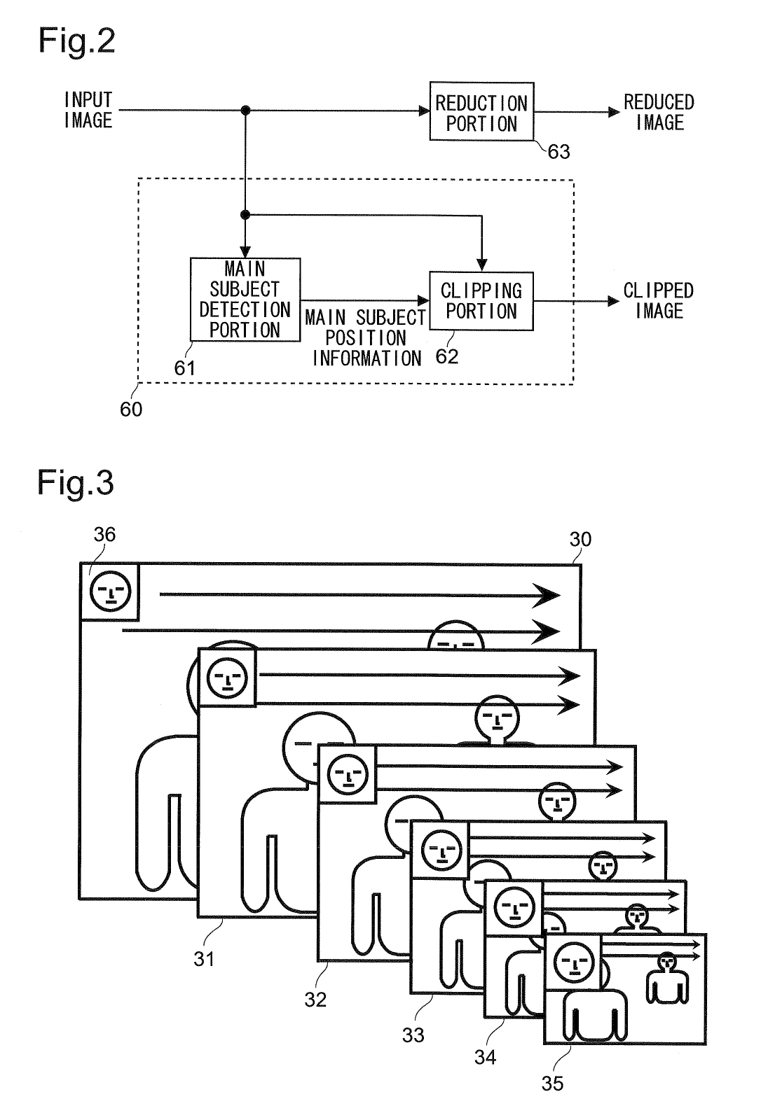

The configuration of the primary portions (especially, portions related to the clipping processing portion 60) of the image-sensing image processing portion 6 shown in FIG. 1 will now be described with reference to the accompanying drawings. FIG. 2 is a block diagram showing the configuration of the primary portions of the image-sensing image processing portion of the embodiment of the prevent invention. In the following description, in order for specific discussion to be made, the image signal that is input to the clipping processing portion 60, where the clipping processing is performed thereon, is expressed as an image and is also referred to as an “input image.” The image signal that is output from the clipping processing portion 60 is referred to as a “clipped image.” The angle of view of the input image is expressed as the entire angle of view. Moreover, the input image may be a simultaneous-colored image.

As shown in FIG. 2, the clipping processing portion 60 is provided with: a main subject detection portion 61 that detects the main subject from the input image and that outputs main subject position information indicating the position of the main subject in the input image; and a clipping portion 62 that clips, based on the main subject position information output from the main subject detection portion 61, a portion of the input image to generate the clipped image. The image-sensing image processing portion 6 is also provided with a reduction portion 63 that reduces the input image to generate a reduced image.

The main subject detection portion 61 detects the main subject from the input image. For example, the main subject detection portion 61 detects the main subject by performing face detection processing on the input image. An example of a face detection processing method will be described with the accompanying drawings. FIG. 3 is a schematic diagram of an image showing the example of the face detection processing method. The method shown in FIG. 3 is only an example, and any known method may be used as the face detection processing method.

In this example, the input image and a weight table are compared, and thus a face is detected. The weight table is determined from a large number of teacher samples (face and non-face sample images). Such a weight table can be made by utilizing, for example, a known learning method called “Adaboost” (Yoav Freund, Robert E. Schapire, “A decision-theoretic generalization of on-line learning and an application to boosting”, European Conference on Computational Learning Theory, Sep. 20, 1995). This “Adaboost” is one of adaptive boosting learning methods in which, based on a large number of teacher samples, a plurality of weak classifiers that are effective for distinction are selected from a plurality of weak classifier candidates, and in which they are weighed and integrated to provide a high accuracy classifier. Here, the weak classifier refers to a classifier that performs classification more accurately than simply accidentally but does not have a sufficiently high accuracy. When weak classifiers are selected, if there already exist selected weak classifiers, learning is intensively performed on teacher samples that erroneously carry out recognition by the effect of the already selected classifiers, with the result that the most effective weak classifiers are selected from the remaining weak classifier candidates.

As shown in FIG. 3, face-detection reduced images 31 to 35 are first generated from an input image 30 by a reduction factor of, for example, 0.8 and are then arranged hierarchically. Determination areas 36 in which determination is performed on the images 30 to 35 are equal in size to each other. As indicated by arrows in the figure, the determination areas 36 are moved from left to right on the images to perform horizontal scanning. This horizontal scanning is performed from top to bottom to scan the entire image. Here, a face image that matches the determination area 36 is detected. In this case, in addition to the input image 30, a plurality of face-detection reduced images 31 to 35 are generated, and this allows different-sized faces to be detected with one type of weight table. The scanning order is not limited to the order described above, and the scanning may be performed in any order.

The matching process is composed of a plurality of determination steps that are performed in ascending order of determination accuracy. When no face is detected in a determination step, the process does not proceed to the subsequent determination step, and it is determined that there is no face in the determination area 36. Only when a face is detected in all the determination steps, it is determined that a face is in the determination area 36, scanning is performed with the determination area and then the process proceeds to determination steps in the subsequent determination area 36. Although, in the example described above, a front face is detected, a side face sample may be used so that the orientation of the face of the main subject or the like is detected. The face of a specific figure is recorded as samples, and face recognition processing may be performed that detects the specific figure as the main subject.

The face detection processing is performed by the above-described method or other method, and thus it is possible to detect, from the input image, a face area including the face of the main subject. Then, information on the position of the detected face area in the input image is output as the main subject position information. A plurality of face areas can be detected, and the main subject position information may indicate a plurality of positions.

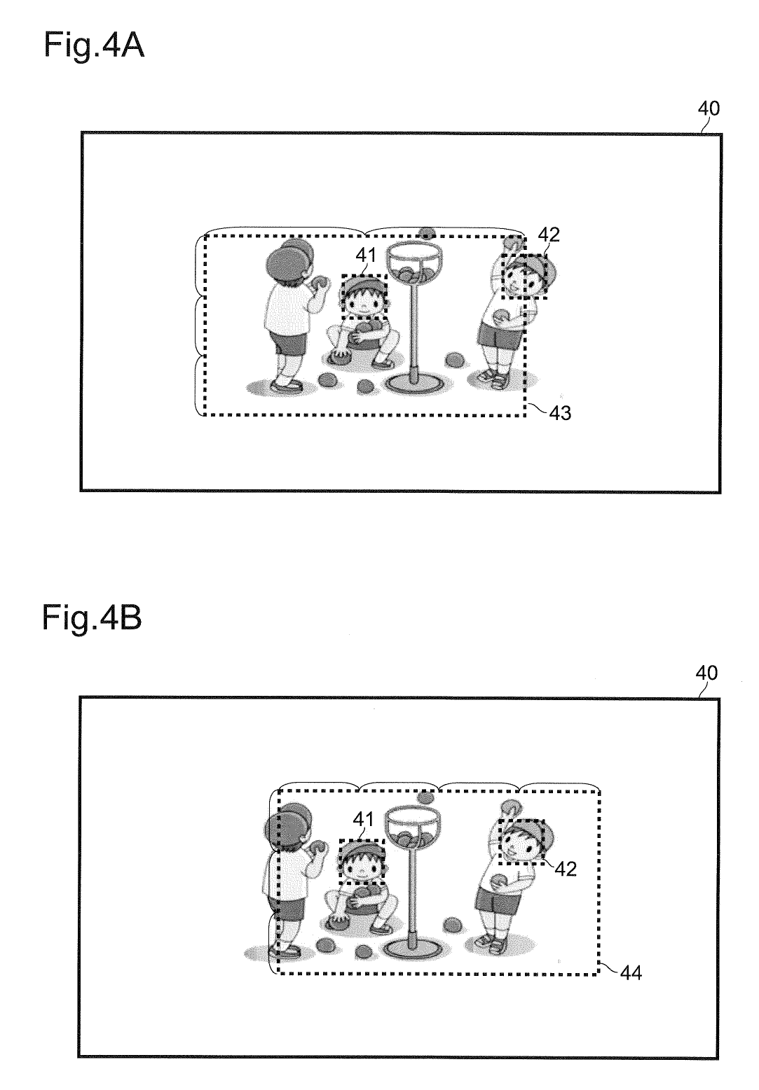

The clipping portion 62 clips a portion of the input image based on the main subject position information. Specific examples of a method of setting the region to be clipped (hereinafter, a clipped region) will be described with the accompanying drawings. FIGS. 4A and 4B are schematic diagrams of an input image showing the examples of the method of setting the clipped region.

In the example shown in FIG. 4A, for example, among face areas 41 and 42 detected by the above-described method, the face area that is located closest to the center of the input image 40 is considered as a reference. Specifically, for example, the face area 41 or 42 whose center is closest to the center of the input image 40 is considered as the reference. The clipped region 43 is set such that the position of the face serving as the reference (for example, the center position of the face area 41) is located at the center of the clipped region 43 in the horizontal direction and at a position one third of the length of the clipped region 43 away from above in the vertical direction. By setting the clipped region 43 in this way, it is possible to locate the main subject at the center of the clipped region 43.

On the other hand, in the example shown in FIG. 4B, a plurality of faces detected are considered as the reference. The clipped region 44 is set such that the average position of the faces (for example, the center positions of the face areas 41 and 42) serving as the reference in the vertical direction is located at a position one third of the length of the clipped region 44 away from above in the vertical direction. Moreover, the clipped region 44 is set such that the positions of the faces detected fall within one half (specifically, two sections in the middle out of four sections into which the clipped region 44 is divided in the horizontal direction) of a center portion in the horizontal direction of the clipped region 44. By setting the clipped region 44 in this way, it is possible to locate a plurality of main subjects at the center of the clipped region 44.

The clipped regions 43 and 44 set as described above preferably have a predetermined size (that is, a predetermined number of pixels) so that the processing performed in the compression processing portion 8, the image output circuit portion 13 and the like in the subsequent stages remains unchanged. When the clipped region is set to have a predetermined size, and a plurality of faces are included in the clipped region as shown in FIG. 4B, for example, problems arise such as one in which not all the faces fall within one half of the center portion in the horizontal direction. In this case, the clipped region may be set such that the faces are brought close to the center (for example, the average position of the faces in the horizontal direction is located at the center of the clipped region in the horizontal direction).

The face serving as the main subject may be selected by the user. For example, the operation portion 17 is provided with a touch panel, and the user may directly select the face. The operation portion 17 is provided with a button such as a direction key, and the user may select the face by operating the button. Moreover, a plurality of faces may be selected; priorities are given to the selected faces, and the clipped region may be set such that the face with a higher priority is preferentially located closer to the center of the clipped region.

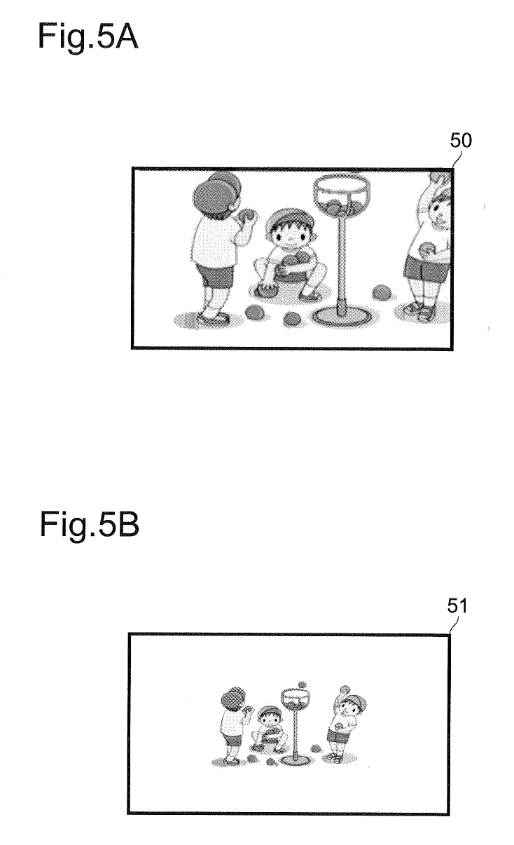

Examples of the clipped image and the reduced image will be described with the accompanying drawings. FIGS. 5A and 5B are schematic diagrams showing the examples of the clipped image and the reduced image. FIGS. 5A and 5B show a clipped image 50 and a reduced image 51, respectively, when the clipped region 43 shown in FIG. 4A is set.

As in the example described above, the clipping processing portion 60 clips, from the input image 40 shown in FIG. 4A, the image of the clipped region 43 to generate and output the clipped image 50. On the other hand, the reduction portion 63 performs reduction processing on the input image 40 to generate and output the reduced image 51. The reduction processing is performed by executing, for example, pixel addition processing or skipping processing, with the result that the number of pixels is reduced.

Here, the number of pixels of the reduced image 51 and the number of pixels of the clipped image 50 are preferably equal to each other because the processing performed in the compression processing portion 8, the image output circuit portion 13 and the like in the subsequent stages can remain unchanged. For example, the input image 40 may have 3840 pixels in a horizontal direction by 2160 pixels in a vertical direction; the clipped image 50 and the reduced image 51 may have 1920 pixels in a horizontal direction by 1080 pixels in a vertical direction. In this case, the clipped image 50 and the reduced image 51 have half the length of the input image 40 in a horizontal direction and half the length of the input image 40 in a vertical direction, with the result that the entire size thereof is one fourth that of the input image 40.

The reduced image 51 output from the reduction portion 63 is substantially equal in angle of view to the input image 40. Since the reduced image 51 is an image that is obtained by performing the reduction processing on the input image 40, the amount of data thereof is reduced as compared with the input image 40. Thus, the image quality (resolution) of the reduced image 51 is lowered as compared with the input image 40.

On the other hand, since the clipped image 50 output from the clipping processing portion 60 is not subjected to processing such as the reduction processing, the clipped image 50 is substantially equal in quality to the input image 40. Since the clipped image 50 is an image that is obtained by clipping a portion of the input image 40, the amount of data thereof is reduced as compared with the input image 40. Since the clipped image 50 is an image of a partial region of the input image 40, the angle of view thereof is narrow as compared with the input image 40.

The clipped image 50 and the reduced image 51 are input to the compression processing portion 8; they are also input to the playback image processing portion 12 via the bus 20 and the memory 16. The clipped image 50 and the reduced image 51 input, to the compression processing portion 8 are compressed and recorded in the external memory 10. On the other hand, the clipped image 50 and the reduced image 51 input to the playback image processing portion 12 are used to be displayed to the user, for example, when the preview is performed before the recording or when the recording is performed.

### <Playback Image Processing Portion>

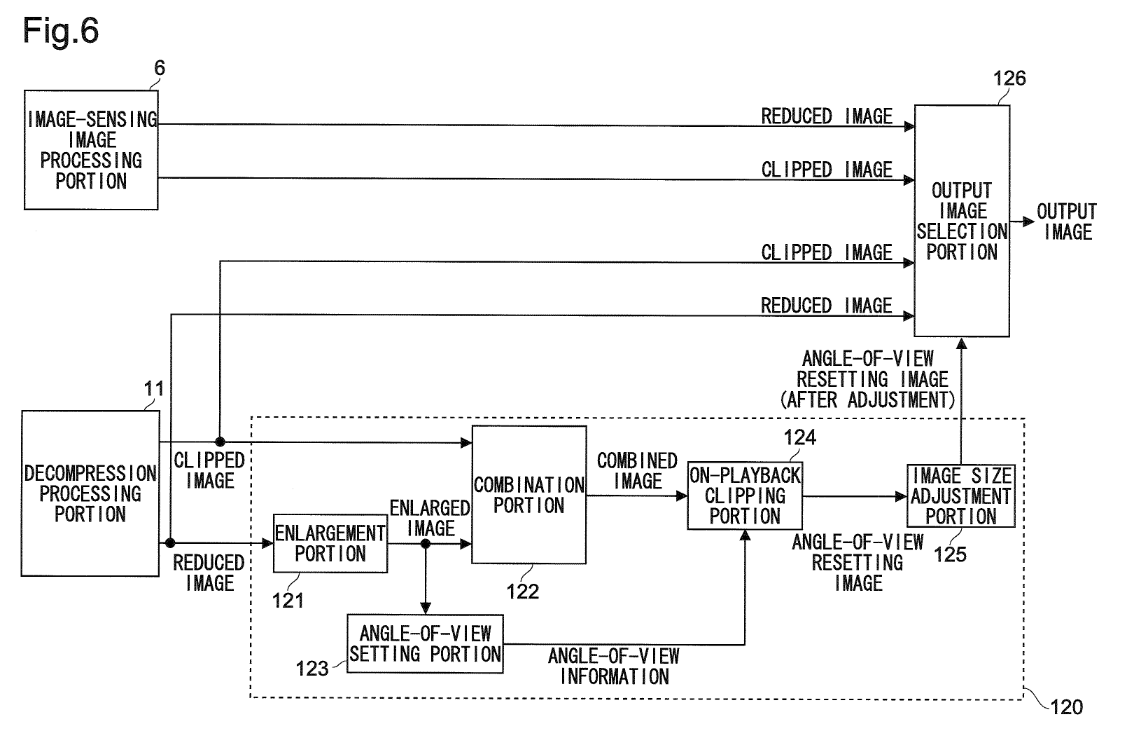

The configuration of the primary portions (especially, portions related to the combination processing portion 120) of the playback image processing portion 12 shown in FIG. 1 will now be described with reference to the accompanying drawings. FIG. 6 is a block diagram showing the configuration of the primary portions of the playback image processing portion of the embodiment of the prevent invention.

As shown in FIG. 6, the combination processing portion 120 is provided with: an enlargement portion 121 that performs enlargement processing on the reduced image output from the decompression processing portion 11 to generate an enlarged image; a combination portion 122 that combines together the clipped image output from the decompression processing portion 11 and the enlarged image output from the enlargement portion 121 to generate a combined image; an angle-of-view setting portion 123 that sets, based on the enlarged image output from the enlargement portion 121, an angle of view to generate information on the angle of view; an on-playback clipping portion 124 that clips, based on the angle-of-view information output from the angle-of-view setting portion 123, a portion of the combined image to generate an angle-of-view resetting image; and an image size adjustment portion 125 that adjusts the size of the angle-of-view resetting image output from the on-playback clipping portion 124 to generate an angle-of-view resetting image (after the adjustment).

The playback image processing portion 12 is also provided with an output image selection portion 126 that selects any of the clipped image and the reduced image output from the image-sensing image processing portion 6, the clipped image and the reduced image output from the decompression processing portion 11 and the angle-of-view resetting image (after the adjustment) output from the combination processing portion 120 to output it as an output image.

As described above, the compression-coded images (the clipped image and the reduced image) recorded in the external memory 10 shown in FIG. 1 are decompressed by the decompression processing portion 11 and are input to the playback image processing portion 12. The reduced image output from the decompression processing portion 11 is input to the enlargement portion 121, where the enlargement processing is performed on the reduced image and thus the enlarged image is generated. The enlargement processing, for example, refers to processing in which pixel interpolation processing or the like is performed and thus the number of pixels is increased. The enlarged image is an image that is obtained by performing the enlargement processing on the reduced image such that the enlarged image is substantially equal to the input image.

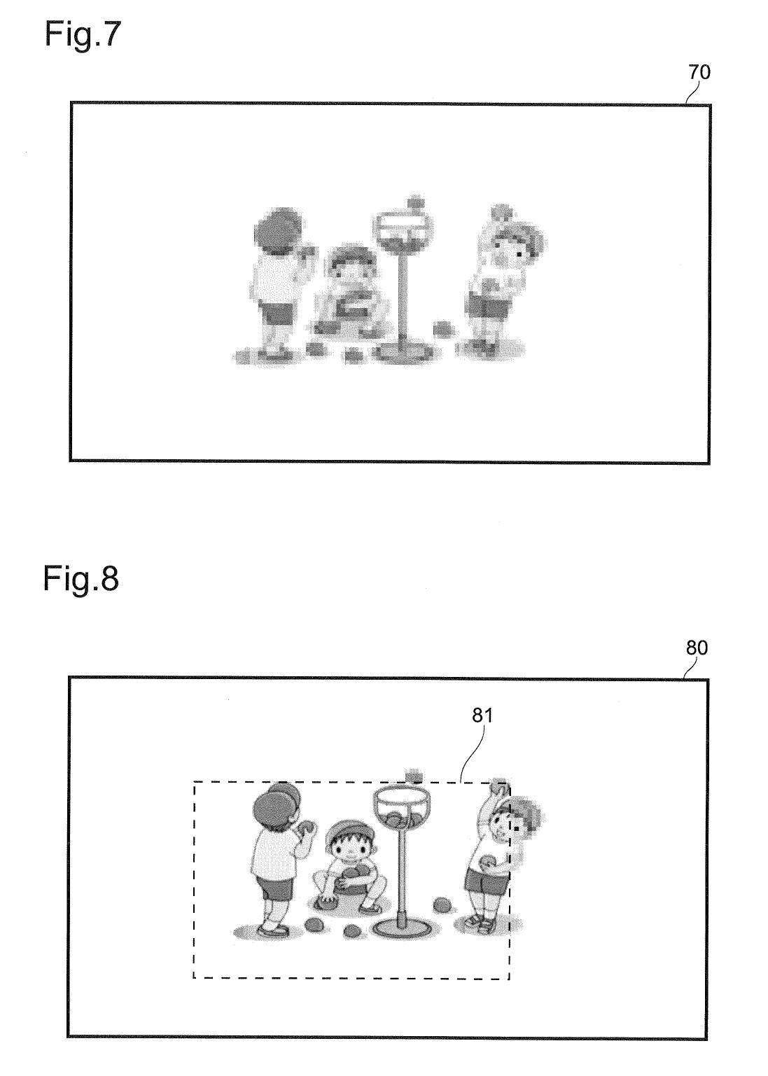

An example of the enlarged image will be described with the accompanying drawings. FIG. 7 is a schematic diagram showing the example of the enlarged image. An enlarged image 70 shown in FIG. 7 is obtained by performing the enlargement processing on the reduced image 51 shown in FIG. 5B. That is, the enlarged image 70 is obtained by performing the reduction processing and the enlargement processing on the input image 40 shown in FIG. 4. For this reason, as shown in FIG. 7, the enlarged image 70 is lower in image quality than the input image 40 shown in FIG. 4.

The clipped image output from the decompression processing portion 11 is input to the combination portion 122, where the clipped image is combined with the enlarged image. Here, the enlarged image is obtained by performing enlargement such that the enlarged image is substantially equal to the input image, and the clipped image is obtained by clipping a portion of the input image. Hence, these images each have approximately the same scaling factor as the input image (an enlargement factor of one). Thus, it is possible to directly perform combination processing on these images without the need to adjust the size of the images.

The combination processing performed by the combination portion 122 refers to processing in which, in the region of a portion of the enlarged image, the clipped image is combined with the enlarged image. The region of the portion of the enlarged image refers to a region of the same position as the region (the clipped region set by the clipping portion 62 shown in FIG. 2) where the clipping is performed to obtain the clipped image. That is, it refers to the clipped region in the enlarged image. The combined image obtained is substantially equal in size to the input image.

An example of the combined image will be described with the accompanying drawings. FIG. 8 is a schematic diagram showing the example of the combined image. A combined image 80 shown in FIG. 8 is obtained by combining the enlarged image 70 shown in FIG. 7 with the clipped image 50 shown in FIG. 5A. A region 81 of the combined image 80 where the clipped image is combined is represented by broken lines. As shown in FIG. 8, the image quality of the region 81 where the clipped image is combined is substantially equal to that of the input image, and thus the image quality is high. On the other hand, the image quality of regions other than the region 81 is substantially equal to that of the enlarged image, and thus the image quality is low.

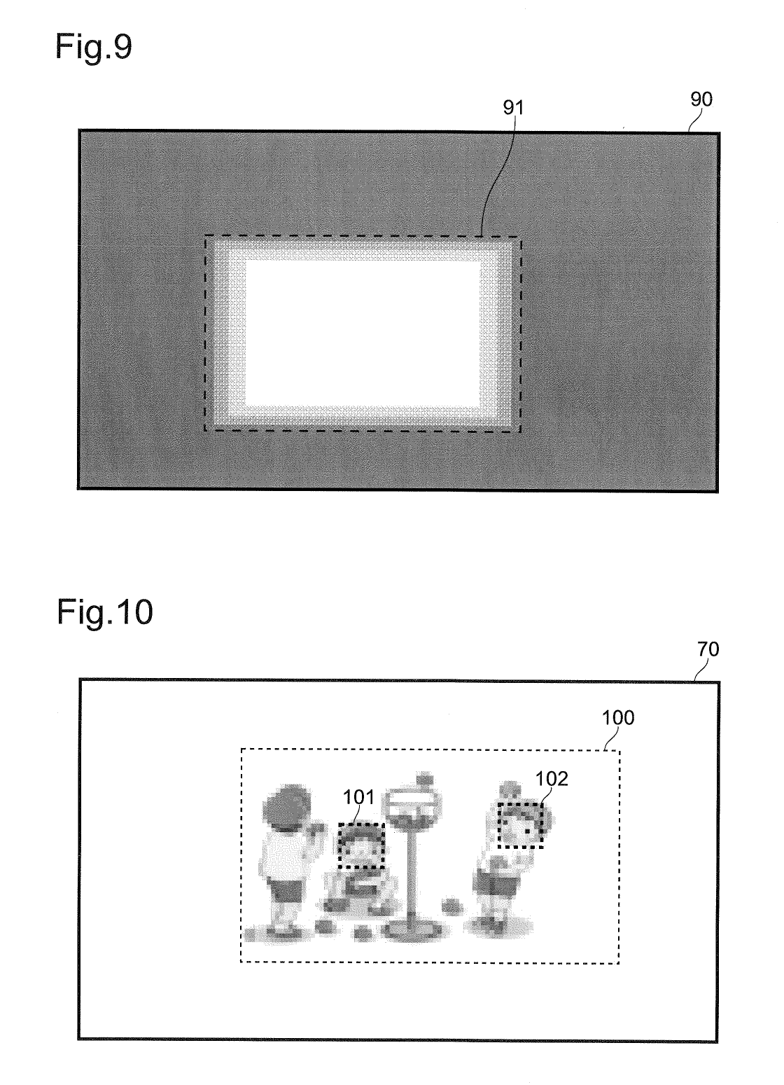

When the combination processing is performed, it is possible not only to combine the clipped image with the enlarged image but also to blur the edge portion of the combined region to make the boundary unnoticeable. An example of the processing that blurs the edge portion will be described with the accompanying drawings. FIG. 9 is a schematic diagram of the combined image showing the example of the processing that blurs the edge portion. In FIG. 9, the combined proportion is represented by colors. Specifically, a region represented by white color refers to a region in which the proportion of signal values of the clipped image is large. A region represented by black color refers to a region in which the proportion of signal values of the enlarged image is large.

In the combined image 90 shown in FIG. 9, a region 91 where the clipped image is combined is designed such that, from the edge portion to the center portion, the proportion of the signal values of the clipped image is increased and the proportion of the signal values of the enlarged image is decreased. In this way, the edge portion of the region 91 where the clipped image is combined is gradually varied in image quality. Thus, it is possible to make unnoticeable the boundary of the region 91 where the clipped region is combined.

The angle-of-view setting portion 123 sets, based on the enlarged image that is input, the angle of view of an image to be played back (a playback angle-of-view region). An example of a method of setting the playback angle-of-view region with the angle-of-view setting portion 123 will be described with the accompanying drawing. FIG. 10 is a schematic diagram of an enlarged image showing the example of the method of setting the playback angle-of-view region with the angle-of-view setting portion. FIG. 10 shows a case where the playback angle-of-view region is set based on the enlarged image 70 shown in FIG. 7.

As shown in FIG. 10, the playback angle-of-view region 100 is set based on the enlarged image 70. For example, as with the clipping portion 62 of FIG. 2, the main subject is detected with a method such as the face detection, and thus the playback angle of view is set. The example shown in FIG. 10 shows a case where the playback angle-of-view region 100 is set to include faces (face areas 101 and 102) detected within the enlarged image 70. Here, the size of the playback angle-of-view region 100 can be freely set. For example, the size is set to satisfy conditions instructed by the user or the like.

The on-playback clipping portion 124 clips, from the combined image, a region corresponding to the playback angle-of-view region indicated by the angle-of-view information input from the angle-of-view setting portion 123 to generate the angle-of-view resetting image. The image size adjustment portion 125 adjusts the size of the angle-of-view resetting image to output the angle-of-view resetting image (after the adjustment). Here, the image size adjustment portion 125 performs, for example, pixel interpolation processing to enlarge the image or performs the addition processing or the skipping processing to reduce the image, and thereby generates the angle-of-view resetting image (after the adjustment).

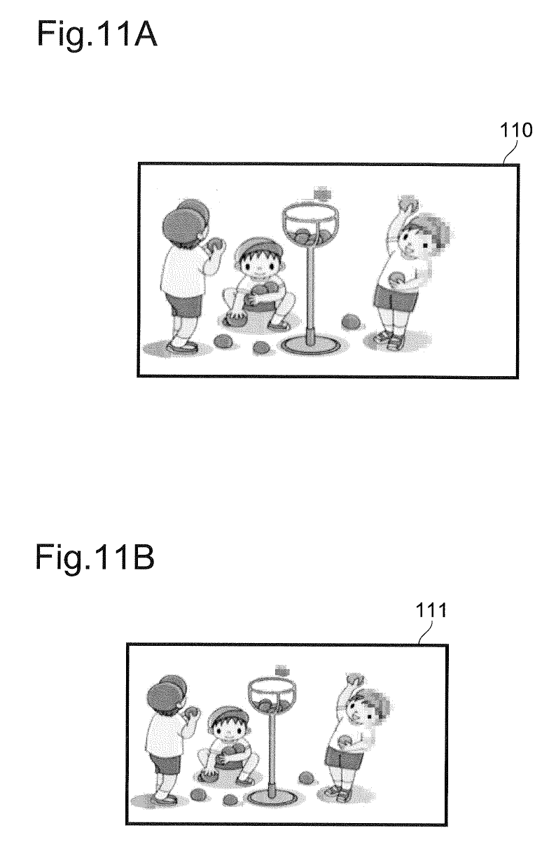

The angle-of-view resetting image and the angle-of-view resetting image (after the adjustment) will be described with reference to the accompanying drawings. FIGS. 11A and 11B are schematic diagrams showing examples of the angle-of-view resetting image and the angle-of-view resetting image (after the adjustment), respectively. An angle-of-view resetting image 110 shown in FIG. 11A is an image that is obtained by clipping, from the combined image 80 shown in FIG. 8, the region corresponding to the playback angle-of-view region 100 shown in FIG. 10. An angle-of-view resetting image (after the adjustment) 111 shown in FIG. 11B is an image that is obtained by adjusting the size of the angle-of-view resetting image 110 shown in FIG. 11A.

As shown in FIG. 11A, the angle-of-view resetting image 110 is obtained by clipping a portion of the combined image 80. Thus, depending on the position of the playback angle-of-view region 100 that is set, as shown in FIG. 11A, a region where the image quality is high (the region 81 where the clipped image of the combined image 80 is combined) and a region where the image quality is low (regions other than the region 81 where the clipped image of the combined image 80 is combined) are included.

The angle-of-view resetting image (after the adjustment) 111 shown in FIG. 11B is obtained by reducing the angle-of-view resetting image 110. The angle-of-view resetting image (after the adjustment) 111, for example, has a predetermined size (for example, 1920 pixels in a horizontal direction by 1080 pixels in a vertical direction) that is substantially equal to the size of the clipped image or the reduced image. When the size of the playback angle-of-view region is larger than the predetermined size, as shown in FIG. 11B, the angle-of-view resetting image is reduced and thus the angle-of-view resetting image (after the adjustment) is generated. On the other hand, when the size of the playback angle-of-view region is smaller than the predetermined size, the angle-of-view resetting image is enlarged and thus the angle-of-view resetting image (after the adjustment) is generated. When the size of the playback angle-of-view region is equal to the predetermined size, the angle-of-view resetting image is used, without being processed, as the angle-of-view resetting image (after the adjustment).

The output image selection portion 126 selects any of various images that are input, and outputs it as an output image. For example, on the sensing of an image, the output image selection portion 126 selects and outputs either of the clipped image and the reduced image input from the image-sensing image processing portion 6. On playback, the output image selection portion 126 selects and outputs any of the clipped image and the reduced image output from the decompression processing portion 11 and the angle-of-view resetting image (after the adjustment) output from the combination processing portion 120. A plurality of images may be output; an image (for example, a reduced image that displays the position of the clipped region) to which predetermined information is added may be output as an output image. A method of selecting an image by the output image selection portion 126, that is, a method of selecting an image that is displayed to the user will be described in detail later.

In this way, the image that, when sensed, is recorded is converted into the reduced image and the clipped image. That is, the image that has a smaller amount of data than the input image is recorded. Thus, it is possible not only to reduce the amount of data necessary to be recorded but also to rapidly perform different types of processing on the image. The clipped image including the image of the main subject is so recorded as to have the same image quality as the input image. Thus, it is possible to record, with high image quality, the image of a region that is highly likely to be required especially by the user.

Even when the desired region is not included in the clipped image that is recorded, the use of the angle-of-view resetting image (after the adjustment) allows the desired region to be easily checked by the user on playback. For example, the playback angle-of-view region 100 shown in FIG. 10 is enlarged, and thus the playback angle-of-view region 100 may be set to include the images of the main subject and the landscape around the main subject. In this case, it is possible to obtain, on playback, the variation of an angle of view similar to that obtained when the main object is zoomed out on the sensing of an image. In contrast, the playback angle-of-view region 100 is set small, and thus it is possible to zoom in the main subject. For example, the playback angle-of-view region 100 may be moved from side to side and up and down. In this case it is possible to obtain the variation of an angle of view similar to that obtained when the image sensing device is panned or tilted on the sensing of an image.

The clipping portion 62 in the clipping processing portion 60 shown in FIG. 2 and the on-playback clipping portion 124 in the combination processing portion 120 shown in FIG. 6 read, from the input image and the combined image temporarily stored in the memory 16, an unillustrated VRAM (video random access memory) and the like, only signals for the clipped region and the playback angle-of-view region, with the result that the clipping processing may be performed.

The input image may be either a moving image or a still image. However, the following description of a display image control operation discusses a case where the input image is a moving image.

### <<Display Image Control>>

An example of controlling a display image will now be described. The control of the display image is performed largely through the selection of an image to be output by the output image selection portion 126 shown in FIG. 6. Examples of controlling a display image on the sensing of an image and on playback will be described below with reference to the accompanying drawings. In particular, reference is given to FIGS. 1, 2, 6 and 12 to 14.

### <On the Sensing of an Image>

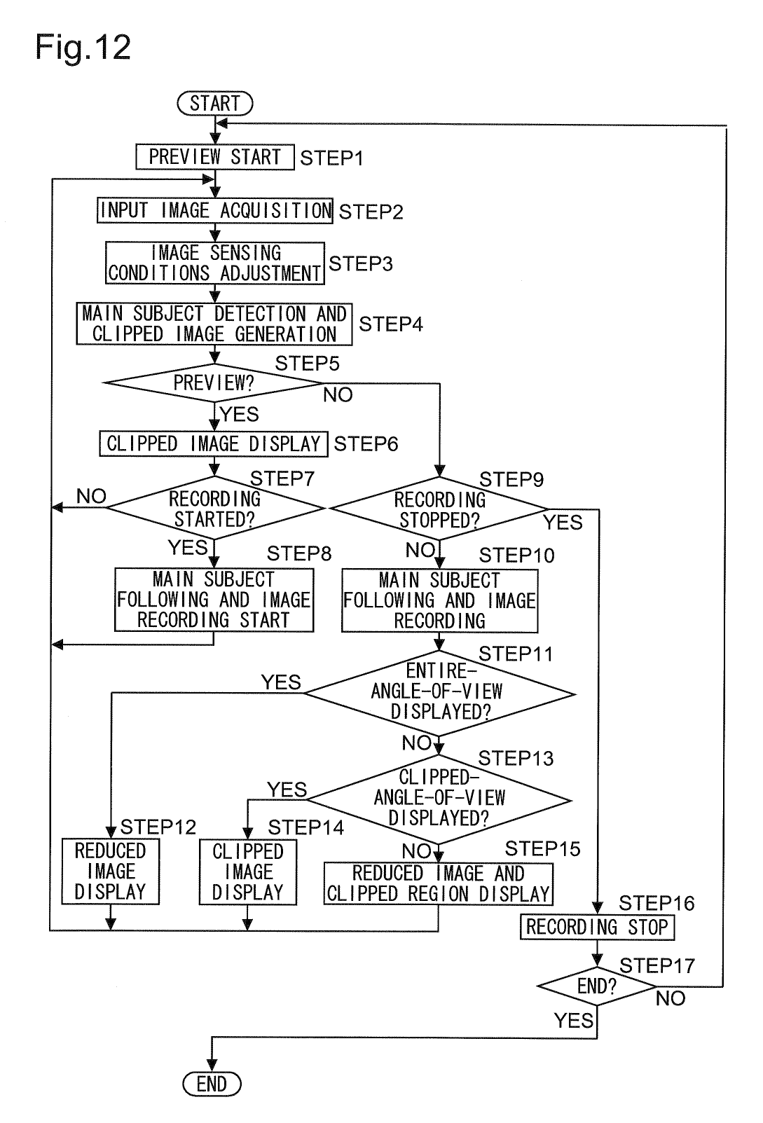

FIG. 12 is a flowchart showing the example of controlling the display image on the sensing of an image. As shown in FIG. 12, when the sensing of an image is started, the preview is first performed. When the preview is started (step 1), the input image is first acquired by the image-sensing image processing portion 6 (step 2). The image-sensing image processing portion 6 adjusts, based on the input image acquired, various image sensing conditions such as the focus, the exposure and the white balance (step 3).

The main subject detection portion 61 in the clipping processing portion 60 detects the main subject in the input image. Then, the clipping portion 62 determines the clipped region and performs the clipping processing (step 4). Then, if the preview is being performed (step 5, yes), the clipped image generated in step 4 is displayed (step 6). Here, the clipped image generated in step 4 is an image that is output from the image-sensing image processing portion 6 and that is input to the output image selection portion 126 via the bus 20 and the memory 16 and that is output as an output image from the output image selection portion 126. Then, the clipped image is displayed on the display device included in, for example, the image sensing device 1.

Then, whether or not an instruction to start the recording is input from the user is checked (step 7). If no instruction to start the recording is input (step 7, no), the process returns to step 2, where the subsequent input image is acquired. Then, the acquired input image is subjected to the operations in steps 3 through 6.

On the other hand, if the instruction to start the recording is input (step 7, yes), the main subject is followed, and the recording of an image is started (step 8). The following of the main subject means that the main subject is continuously detected as follows: for example, the result (for example, a detected position) obtained by detecting the main subject in a given input image is utilized for detection of the main subject in the subsequently acquired input image; and the same subject as the detected subject is detected from the subsequently acquired input image. The recording of an image means that, as described above, the clipped image and the reduced image output form the image-sensing image processing portion 6 are compression-coded by the compression processing portion 8 and are recorded in the external memory 10.

After the completion of step 8, the process returns to step 2, where the subsequent input image is acquired. Then, the acquired input image is subjected to the operations in steps 3 and 4. Here, since the recording is already started and the preview is completed (step 5, no), whether or not an instruction to stop the recording is input is checked (step 9).

If the instruction to stop the recording is input (step 9, yes), the recording is stopped (step 16), and then whether or not an instruction to complete the sensing of an image is input is checked (step 17). If the instruction to complete the sensing of an image is input (step 17, yes), the sensing of an image is completed. On the other hand, if no instruction to complete the sensing of an image is input (step 17, no), the process returns to step 1, where the preview is started.

If no instruction to stop the recording is input (step 9, no), as in step 8, the following of the main subject is continued, and the image is recorded (step 10). Then, the recorded image is displayed to the user (steps 11 to 15). Here, the image is displayed on the display device included in, for example, the image sensing device 1.

If the image of the entire angle of view is set to be displayed (step 11, yes), the reduced image that is the image of the entire angle of view is displayed (step 12). The reduced image that is displayed is an image that is output from the image-sensing image processing portion 6 and that is input to the output image selection portion 126 via the bus 20 and the memory 16 and that is output as an output image from the output image selection portion 126.

On the other hand, if the image of the entire angle of view is not set to be displayed (step 11, no) but the image of a clipped angle of view is set to be displayed (step 13, yes), the clipped image that is the image of the clipped angle of view is displayed (step 14). The clipped image that is displayed is an image that is output from the image-sensing image processing portion 6 and that is input to the output image selection portion 126 via the bus 20 and the memory 16 and that is output as an output image from the output image selection portion 126.

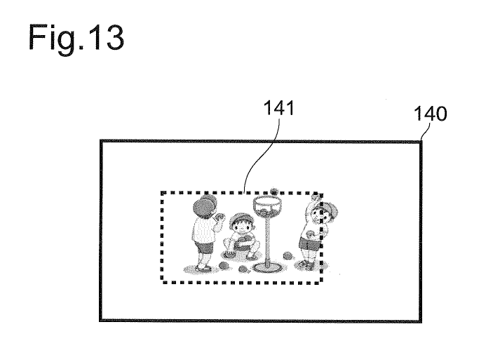

If the image of the clipped angle of view is not set to be displayed (step 13, no), an image in which the clipped region is displayed on the reduced image is displayed (step 15). This reduced image is output from the image-sensing image processing portion 6 and is input to the output image selection portion 126 via the bus 20 and the memory 16. Then, likewise, information indicating the position of the clipped region is input to the output image selection portion 126, and an output image in which the position of the clipped region is added to the reduced image is generated and output. For example, as shown in FIG. 13, an output image 140 in which the position 141 of the clipped region is added to and displayed on the reduced image may be displayed.

After the above-described operations in steps 11 to 15 are performed to display the image, the process returns to step 2, where the subsequent input image is acquired. Then, as described above, this input image is subjected to the operations in step 3 and the subsequent steps.

Although, in step 6, the image displayed on preview is the clipped image, it may be the reduced image. An image in which the clipped image is added to the reduced image may be used instead. A selection may be made from these images.

### <On Playback>

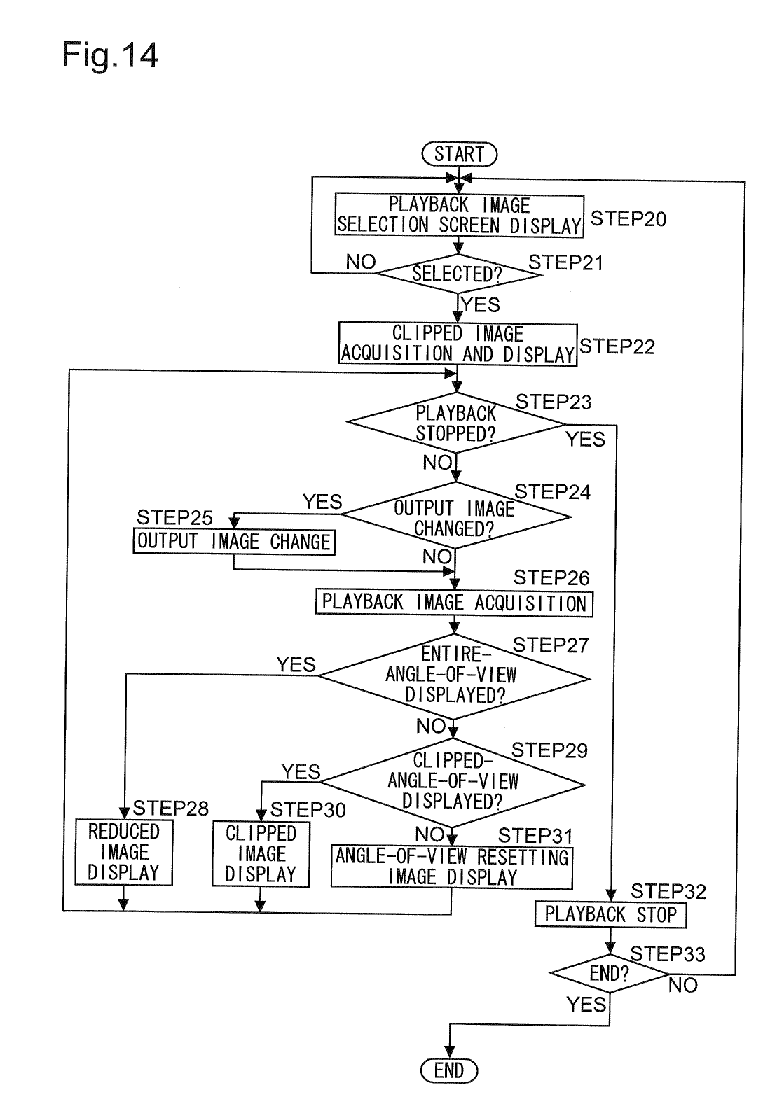

FIG. 14 is a flowchart showing the example of controlling the display image on playback. As shown in FIG. 14, when the playback is started, a screen for selection of an image to be played back initially is displayed (step 20). For example, a recorded thumbnail image is displayed to make the user select the image to be played back. If the user does not select the image to be played back (step 21, no), the selection screen in step 20 is continuously displayed.

If the user selects the image to be played back (step 21, yes), the clipped image of the selected image is acquired and displayed (step 22). The clipped image is an image that is recorded in the external memory 10; the clipped image is output from the decompression processing portion 11 and is input to the output image selection portion 126, and is output from the output image selection portion 126 as an output image.

Whether or not an instruction to stop the playback is input is checked (step 23). If the instruction to stop the playback is input (step 23, yes), the playback is stopped (step 32), and whether or not an instruction to complete the playback is input is checked (step 33). If the instruction to complete the playback is input (step 33, yes), the playback is completed. On the other hand, if the instruction to complete the playback is not input (step 33, no), the process returns to step 20, where the image selection screen is displayed.

If the instruction to stop the playback is not input (step 23, no), whether or not to change the output image is checked (step 24). When the playback is started, as the initial setting, the clipped image is set to be displayed. However, the user may wish to change the angel of view on playback. In this case, an instruction to change the output image is given (step 24, yes), and the output image is changed (step 25). On the other hand, if the instruction to change the output image is not given (step 24, no), the image of the currently set angle of view is continuously displayed.

When the angle of view of the output image is determined in step 24, then the image to be played back is acquired (step 26). Specifically, the clipped image and the reduced image are read from the decompression processing portion 11 by the combination processing portion 120; they are read by the output image selection portion 126. Then, the output image is displayed to the user (steps 27 to 31).

If the image of the entire angle of view is set to be displayed (step 27, yes), the reduced image that is the image of the entire angle of view is displayed (step 28). The reduced image that is displayed is an image that is output from the decompression processing portion 11 and that is input to the output image selection portion 126, and that is output from the output image selection portion 126 as an output image.

On the other hand, if the image of the entire angle of view is not set, to be displayed (step 27, no) but the image of the clipped angle of view is set to be displayed (step 29, yes), the clipped image that is the image of the clipped angle of view is displayed (step 30). The clipped image that is displayed is an image that is output from the decompression processing portion 11 and that is input to the output image selection portion 126, and that is output from the output image selection portion 126 as an output image.

If the image of the clipped angle of view is not set to be displayed (step 29, no), the angle-of-view resetting image (after the adjustment) is displayed (step 31). As described above, the angle-of-view resetting image (after the adjustment) is generated through the processing of the clipped image and the reduced image output from the decompression processing portion 11 by the combination processing portion 120. Then, the angle-of-view resetting image (after the adjustment) thus generated is input to the output image selection portion 126 and is output from the output image selection portion 126 as an output image.

After the above-described operations in steps 27 to 31 are performed to display the image, the process returns to step 23, where whether or not to stop the playback is checked. Then, as described previously, the operations in step 24 and the subsequent steps are performed.

### Modified Examples

### <Enlargement Portion>

Although, in the above-described example, the enlargement portion 121 in the combination processing portion 120 performs, for example, the interpolation processing so that the number of pixels of the reduced image that is input is increased, in addition to (or instead of) the interpolation processing, super-resolution processing may be performed.

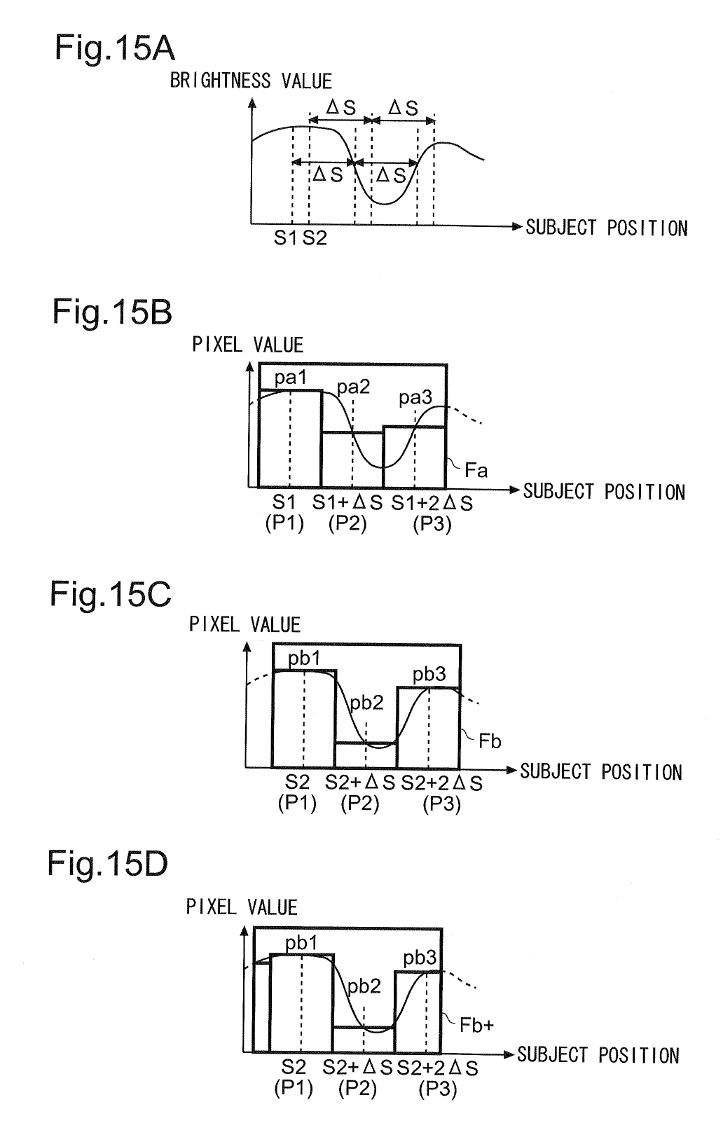

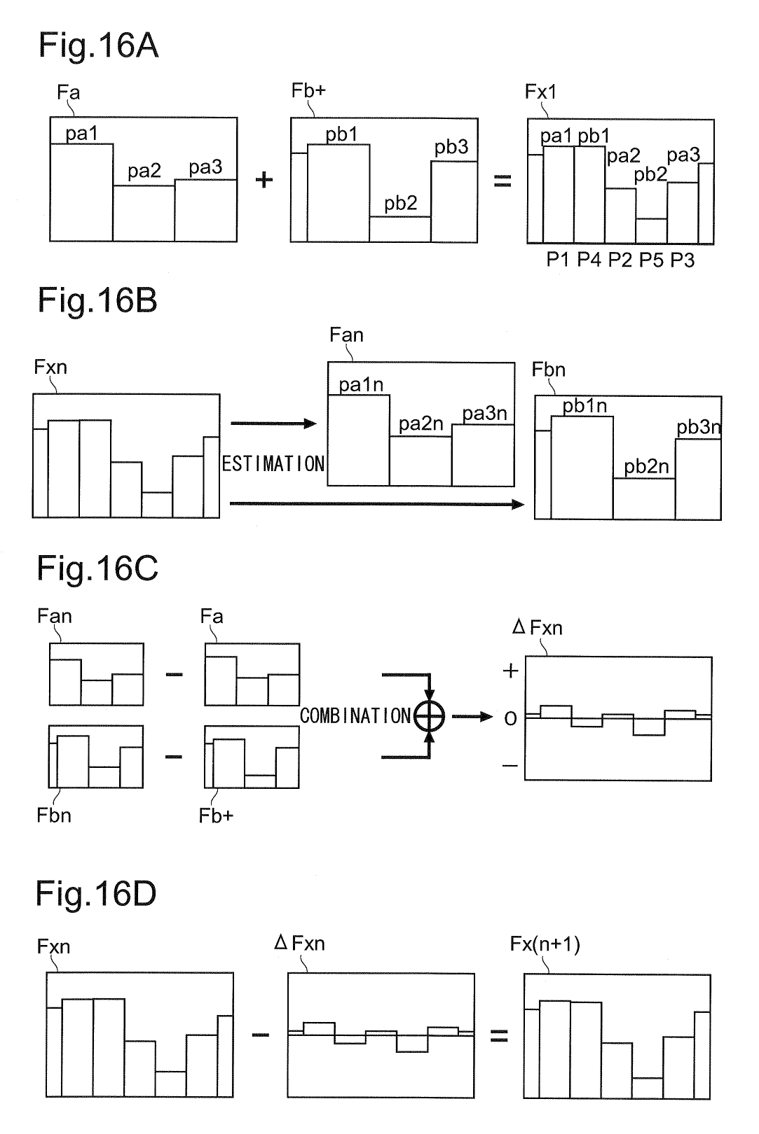

When the super-resolution processing is performed, it is possible to enhance the quality of the enlarged image that is obtained. Thus, it is possible not only to enhance the accuracy with which the angle-of-view setting portion 123 detects the main subject but also to enhance the quality of the angle-of-view resetting image (after the adjustment) output from the combination processing portion 120. The following description discusses a case where a MAP (maximum a posterior) method that is one type of super-resolution processing is used; such a case will be described with reference to the accompanying drawings. FIGS. 15A to 15D and FIGS. 16A to 16D are diagrams showing an outline of an example of generating an enlarged image with the super-resolution processing.

In the following description, for ease of description, a plurality of pixels aligned in one direction in the reduced image will be considered. A case where two reduced images are combined together to generate an enlarged image and where pixel values to be combined are brightness values will be described by way of example.

FIG. 15A shows the brightness distribution of a subject to be captured. FIGS. 15B and 15C show the brightness distribution of reduced images obtained from an input image acquired by capturing the subject shown in FIG. 15A. FIG. 15D shows an image obtained by shifting the reduced image shown in FIG. 15C by a predetermined amount. The reduced image shown in FIG. 15B (hereinafter referred to as an actual low-resolution image Fa) and the reduced image shown in FIG. 15C (hereinafter referred to as an actual low-resolution image Fb) are captured at different times.

As shown in FIG. 15B, let S1, S1+ΔS and S1+2ΔS be the positions of sample points in the actual low-resolution image Fa obtained by capturing, at a time point T1, the subject having the brightness distribution shown in FIG. 15A. As shown in FIG. 15C, let S2, S2+ΔS, and S2+2ΔS be the positions of sample points in the actual low-resolution image Fb obtained by capturing the subject at a time point T2 (T1≠T2). Here, it is assumed that the sample point 51 in the actual low-resolution image Fa and the sample point S2 in the actual low-resolution image Fb are displaced from each other due to camera shake or the like. That is, the pixel position is displaced only by (S1−S2).

In the actual low-resolution image Fa shown in FIG. 15B, let the brightness values obtained at the sample points S1, S1+ΔS and S1+2ΔS be pixel values pa1, pa2 and pa3 at pixels P1, P2 and P3. Likewise, in the actual low-resolution image Fb shown in FIG. 15C, let the brightness values obtained at the sample points S2, S2+ΔS and S2+2ΔS be pixel values pb1, pb2 and pb3 at the pixels P1, P2 and P3.

Here, when the actual low-resolution image Fb is displayed relative to the pixels P1, P2 and P3 (the image of interest) in the actual low-resolution image Fa (specifically, when the displacement of the actual low-resolution image Fb is corrected only by the amount of movement thereof (S1−S2) relative to the actual low-resolution image Fa), an actual low-resolution image Fb+ whose positional displacement is corrected is as shown in FIG. 15D.

FIGS. 16A to 16D show a method for generating a high-resolution image by combining together the actual low-resolution image Fa and the actual low-resolution image Fb+. First, as shown in FIG. 16A, the actual low-resolution image Fa and the actual low-resolution image Fb+ are combined together, and thus a high-resolution image Fx1 is estimated. For ease of description, for example, it is assumed that the resolution is doubled in one direction. Specifically, the pixels of the high-resolution image Fx1 are assumed to include the pixels P1, P2 and P3 of the actual low-resolution images Fa and Fb+, the pixel P4 located halfway between the pixels P1 and P2 and the pixel P5 located halfway between the pixels P2 and P3.

As a pixel value at the pixel P4 in the actual low-resolution image Fa, the pixel value pb1 is selected because the distance from the pixel position of the pixel P1 to the pixel position of the pixel P4 in the actual low-resolution image Fb+ is shorter than the distances from the pixel positions (the center positions of the pixels) of the pixels P1 and P2 to the pixel position of the pixel P4 in the actual low-resolution image Fa. Likewise, as a pixel value at the pixel P5, the pixel value pb2 is selected because the distance from the pixel position of the pixel P2 to the pixel position of the pixel P5 in the actual low-resolution image Fb+ is shorter than the distances from the pixel positions of the pixels P2 and P3 to the pixel position of the pixel P5 in the actual low-resolution image Fa.

Thereafter, as shown in FIG. 16B, the high-resolution image Fx1 thus obtained is subjected to calculation using a conversion formula including, as parameters, the amount of down sampling, the amount of blur and the amount of displacement (corresponding to the amount of movement), and thus estimated low-resolution images Fa1 and Fb1, that is, estimated images corresponding to the actual low-resolution images Fa and Fb, respectively, are generated. FIG. 16B shows estimated low-resolution images Fan and Fbn generated from a high-resolution image Fxn that is estimated through the processing performed for the nth time.

For example, when n=1, based on the high-resolution image Fx1 shown in FIG. 16A, the pixel values at the sample points S1, S1+ΔS and S1+2ΔS are estimated, and the estimated low-resolution image Fa1 is generated that has the acquired pixel values pa11 to pa31 as the pixel values of the pixels P1 to P3. Likewise, based on the high-resolution image Fx1, the pixel values at the sample points S2, S2+ΔS and S2+2ΔS are estimated, and the estimated low-resolution image Fb1 is generated that has the acquired pixel values pb11 to pb31 as the pixel values of the pixels P1 to P3. Then, as shown in FIG. 16C, the differences between each of the estimated low-resolution images Fa1 and Fb1 and the corresponding one of the actual low-resolution images Fa and Fb are determined, and these differences are combined together to acquire a differential image ΔFx1 with respect to the high-resolution image Fx1. FIG. 16C shows a differential image ΔFxn with respect to the high-resolution image Fxn acquired through the processing performed for the nth time.

For example, a differential image ΔFa1 has, as the pixel values of the pixels P1 to P3, the difference values (pa11−pa1), (pa21−pa2) and (pa31−pa3), and a differential image ΔFb1 has, as the pixel values of the pixels P1 to P3, the difference values (pb11−pb1), (pb21−pb2) and (pb31−pb3). Then, by combining together the pixel values of the differential images ΔFa1 and ΔFb1, the difference values of the pixels P1 to P5 are calculated, with the result that the differential image ΔFx1 with respect to the high-resolution image Fx1 is acquired. When the differential image ΔFx1 is acquired by combining together the pixel values of the differential images ΔFa1 and ΔFb1, for example, if an ML (maximum likelihood) method or a MAP method is used, squared errors are used as an evaluation function. Specifically, a value obtained by adding, between frames, squared pixel values of the differential images ΔFa1 and ΔFb1 is assumed to be an evaluation function. Thus, the gradient given as the integral of that evaluation function has values twice as great as the pixel values of the differential images ΔFa1 and ΔFb1. Accordingly, the differential image ΔFx1 with respect to the high-resolution image Fx1 is calculated through resolution enhancement using values twice as great as the pixel values of each of the differential images ΔFa1 and ΔFb1.

Thereafter, as shown in FIG. 16D, the pixel values (difference values) of the pixels P1 to P5 in the obtained differential image ΔFx1 are subtracted from the pixel values of the pixels P1 to P5 in the high-resolution image Fx1, with the result that a high-resolution image Fx2 is reconstructed that has pixel values close to the subject having the brightness distribution shown in FIG. 15A. FIG. 16D shows a high-resolution image Fx (n+1) acquired through the processing performed for the nth time.

Then, a series of types of processing described above is repeated such that the pixel values of differential image ΔFxn obtained is decreased and thus the pixel values of the high-resolution image Fxn converge to pixel values close to the subject having the brightness distribution shown in FIG. 15A. When the pixel values (difference values) of the differential image ΔFxn are lower than a predetermined value, or when the pixel values (difference values) of the differential image ΔFxn converges, the high-resolution image Fxn obtained by the previous processing (performed for the (n−1)th time) is output as, for example, an enlarged image from the enlargement portion 121.

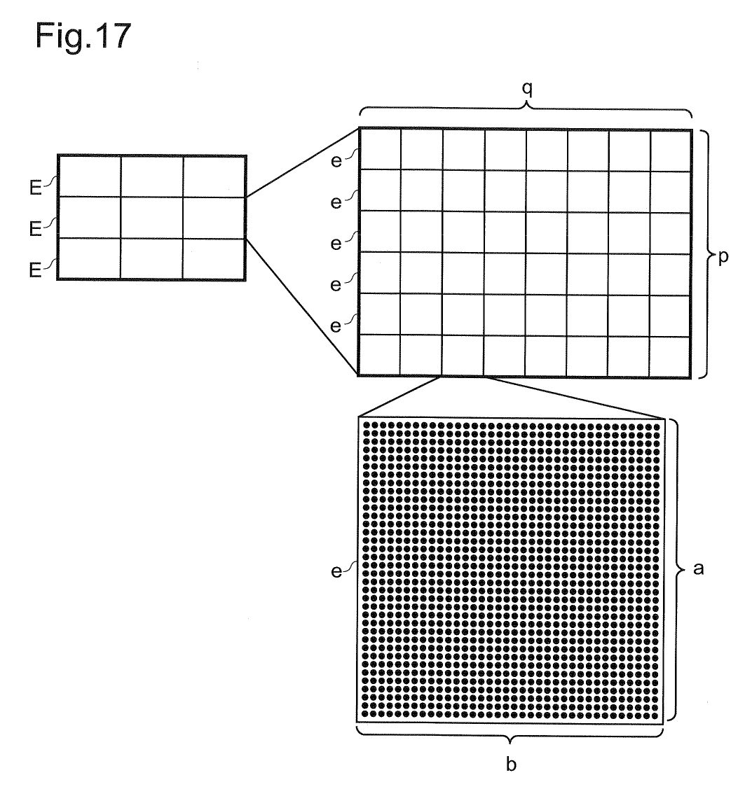

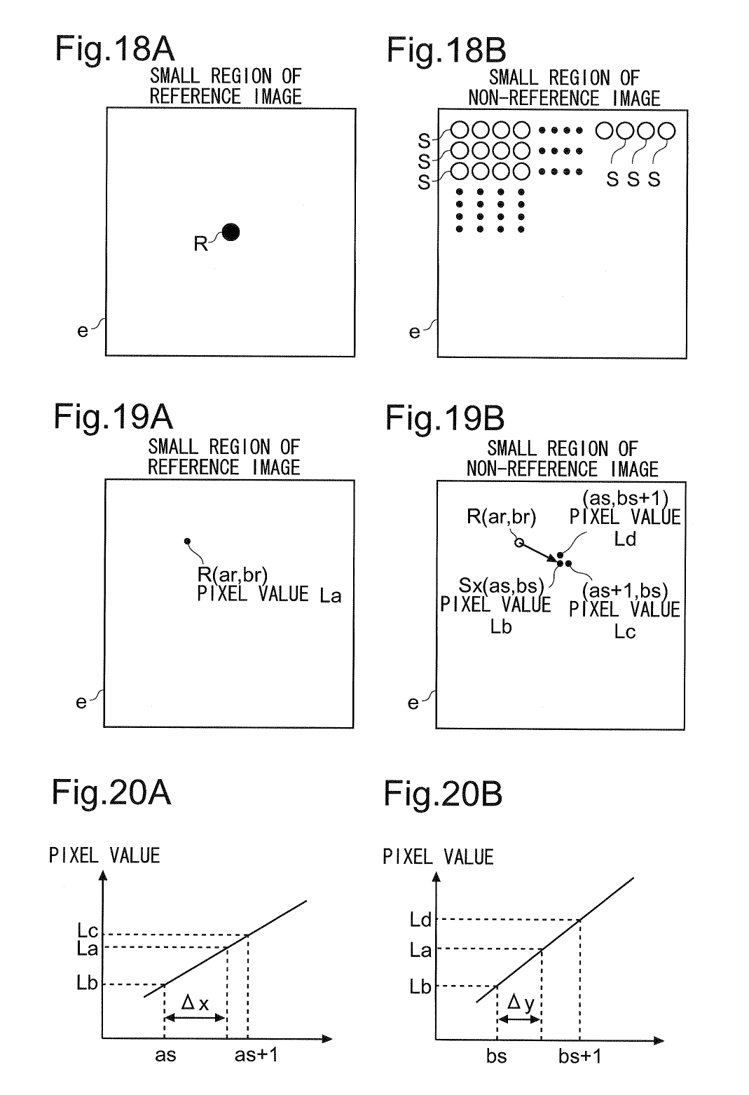

In the above processing, in order to determine the amount of movement (the amount of displacement), it is possible to use, for example, representative point matching and single-pixel movement amount detection as described below. First, the representative point matching, and then the single-pixel movement amount detection will be described with reference to the drawings. FIGS. 17 and 18 are diagrams showing the representative point matching. FIG. 17 is a schematic diagram showing how an image is divided into regions, and FIGS. 18A and 18B are schematic diagrams showing a reference image and a non-reference image.

In the representative point matching, for example, an image serving as a reference (reference image) and an image compared with the reference image to detect movement (non-reference image) are each divided into regions as shown in FIG. 17. For example, an a×b pixel group (for example, a 36×36 pixel group) is divided as one small region “e”, and then a p×q region portion (for example, 6×8 region portion) of such a small region “e” is divided as one detection region E. Moreover, as shown in FIG. 18A, one of the a×b pixels composing the small region “e” is set at the representative point R. On the other hand, as shown in FIG. 18B, a plurality of pixels among the a×b pixels composing the small region “e” is set at sampling points S (for example, all the a×b pixels may be set at the sampling points S).

When the small region “e” and the detection region E are set as described above, with respect to the small region “e” serving as the same position in the reference and non-reference images, the difference between the pixel value at each sampling point S in the non-reference image and the pixel value at the representative point R in the reference image is determined as the correlation value at that sampling point S. Then, for each detection region E, the correlation values at the sampling points S where positions relative to the representative point R coincide with each other between the small regions “e” are added up for all the small regions “e” composing the detection region E, with the result that the cumulative correlation value at each sampling point S is acquired. In this way, for each detection region E, the correlation values at p×q sampling points S where positions relative to the representative point R coincide with each other are added up, with the result that as many cumulative correlation values as there are sampling points are obtained (for example, when all the a×b pixels are set at the sampling points S, a×b cumulative correlation values are obtained).

After, for each detection region E, the cumulative correlation values at the individual sampling points S have been determined, then, for each detection region E, the sampling point S considered to have the highest correlation with the representative point R (i.e., the sampling point S with the lowest cumulative correlation value) is detected. Then, for each detection region E, the movement amounts of the sampling point S with the lowest cumulative correlation value and of the representative point R are determined based on their respective pixel positions. Thereafter, the movement amounts determined for the individual detection regions E are averaged, and thus the average value is detected as the movement amount of each of pixels between the reference and non-reference images.

The single-pixel movement amount detection will now be described with reference to the drawings. FIGS. 19A and 19B are schematic diagrams of a reference image and a non-reference image showing the single-pixel movement amount detection, and FIGS. 20A and 21B are graphs showing the relationship between the pixels values of the reference points and the sampling points during the single-pixel movement amount detection.

After the movement amount of each pixel is detected with, for example, the representative point matching or the like as described above, the movement amount within a single pixel can further be detected with the method described above. For example, for each small regions “e”, with the relationship between the pixel value of the pixel at the representative point R in the reference image and the pixel values of the pixel at and around a sampling point Sx having a high correlation with the representative point R, it is possible to detect the movement amount within a single pixel.

As shown in FIGS. 19A and 19B, for each small region “e”, with the relationship between a pixel value La at the representative point R serving as a pixel position (ar, br) in the reference image, a pixel value Lb at a sample point Sx serving as a pixel position (as, bs) in the non-reference image, a pixel value Lc at a pixel position (as+1, bs) adjacent to the sample point Sx in a horizontal direction and a pixel value Ld at a pixel position (as, bs+1) adjacent to the sample point Sx in a vertical direction, the movement amount within a single pixel is detected. Here, by the representative point matching, the movement amount of each pixel from the reference image to the non-reference image is determined as a value expressed by the vector quantity (as−ar, bs−br).

It is assumed that, as shown in FIG. 20A, deviating horizontally one pixel from the pixel serving as the sample point Sx causes a linear change from the pixel value Lb to the pixel value Lc. Likewise, it is also assumed that, as shown in FIG. 20B, deviating vertically one pixel from the pixel serving as the sample point Sx causes a linear change from the pixel value Lb to the pixel value Ld. Then, the horizontal position Δx (=(La−Lb)/(Lc−Lb)) serving as the pixel value La between the pixel values Lb and Lc is determined, and the vertical position Δy (=(La−Lb)/(Ld−Lb)) serving as the pixel value La between the pixel values Lb and Ld is also determined. That is, a vector quantity represented by (Δx, Δy) is determined as the movement amount within a single pixel between the reference and non-reference pixels.

In this way, the movement amount within a single pixel in each small region “e” is determined. Then, the average obtained by averaging the movement amounts thus determined is detected as the movement amount within a single pixel between the reference image (for example, the actual low-resolution image Fb) and the non-reference image (for example, the actual low-resolution image Fa). Then, by adding the determined movement amount within a single pixel to the movement amount of each pixel obtained by the representative point matching, it is possible to calculate the movement amount between the reference and the non-reference images.

### [Electronic Apparatus]

Although the image sensing device is described as an example of an electronic apparatus according to the present invention, the electronic apparatus of the invention is not limited to the image sensing device. For example, the electronic apparatus may have only a playback function and output an output image (especially an angle-of-view resetting image (after the adjustment)) based on a reduced image and a clipped image that are recorded. The electronic apparatus of the invention may be an editing device that generates and records an output image based on the reduced image and the clipped image that are recorded.

In the image sensing device 1 of the embodiment of the invention, the operations performed such as by the image-sensing image processing portion 6 and the playback image processing portion 12 may be carried out by a control device such as a microcomputer. All or part of the functions achieved by this kind of control device is realized as programs and the programs are executed on a program execution device (for example, a computer), with the result that all or part of the functions may be achieved.

In addition to the above-described case, the image sensing device 1 shown in FIG. 1, the image-sensing image processing portion 6 shown in FIGS. 1 and 2 and the playback image processing portion 12 shown in FIGS. 1 and 6 can be provided either by hardware or by the combination of hardware and software. When the image sensing device 1, the image-sensing image processing portion 6 and playback image processing portion 12 are provided by software, a block diagram for portions that are provided by the software represents a functional block diagram for those portions.

Although the embodiment of the invention is described above, the scope of the invention is not limited to this embodiment, and many modifications are possible without departing from the spirit of the invention.

The present invention relates to an image processing device that clips a portion of an input image to obtain a desired clipped image and an electronic apparatus such as a sensing device, a typical example of which is a digital video camera.

What is claimed is:

1. An image processing device comprising:
an enlargement processing portion enlarging a reduced image obtained by reducing an input image to generate an enlarged image;
a combination portion combining a clipped image that is an image clipped from a clip region that is a partial region of the input image with an image of a region of the enlarged image corresponding to the clip region to generate a combined image; and
an on-playback clipping portion clipping a playback angle-of-view region that is a partial region of the combined image to generate an angle-of-view resetting image.

2. The image processing device of claim 1, further comprising:
a main subject detection portion detecting a position of a main subject in the input image;
a clipping portion clipping the input image at the clip region including the position of the main subject detected by the main subject detection portion to generate the clipped image; and
a reduction portion reducing the input image to generate the reduced image.

3. The image processing device of claim 1, further comprising:
an output image selection portion selecting any one of the reduced image, the clipped image and the angle-of-view resetting image to output the selected image as an output image.

4. The image processing device of claim 1, further comprising:
an angle-of-view setting portion detecting the position of a main subject from the enlarged image and setting, based on the detected position of the main subject, the playback angle-of-view region.

5. The image processing device of claim 1,
wherein the combination portion performs the combination such that, from a side of a region of the combined image corresponding to the clip region to a center thereof, a proportion of the clipped image is increased and a proportion of the enlarged image is decreased.

6. An electronic apparatus comprising:
the image processing device of claim 1,
wherein the electronic apparatus records or plays back an image output from the image processing device.
